(19) United States
(12) Patent Application Publication
(10) Pub. No.: US 2019/0194920 A1
(43) Pub. Date: Jun. 27, 2019

(54) REPLACEMENT P-TRAP SYSTEM

(71) Applicant: John Trkla, Lake Forest, IL (US)

(72) Inventor: John Trkla, Lake Forest, IL (US)

(21) Appl. No.: 15/855,112

(22) Filed: Dec. 27, 2017

(51) Int. Cl. E03C 1/284; F16L 15/00; F16L 37/127

(52) U.S. Cl. CPC E03C 1/284; F16L 37/127; F16L 15/006

(57) ABSTRACT

A replacement p traps for sinks, tubs and any other plumbing system that utilizes P traps in both residential and commercial settings. The present replacement system having a first threaded conduit segment that will engage with the existing free end of the pipe leading from the sink wherein such conduit includes at least one locking means, a second threaded conduit segment that will engage with the existing free end of the pipe leading to the sewer or septic system wherein such conduit includes at least one locking means, and a U shaped bend wherein each end of the bend includes at least one locking means and wherein each end of the bend is designed to connect with the first and second threaded conduits segments.

### FIELD OF THE INVENTION

The present invention relates to plumbing systems, in particular, P-trap systems for plumbing drainage systems. The present invention relates to p trap systems that are used with drains for sinks, and other such plumbing fixtures in both residential and commercial applications.

### BACKGROUND ART

Plumbing systems have employed p-traps for a long time to act as a vapor barrier between an open drain in a sink and the connection to the sewer system or septic holding tank. P traps were designed to provide a U-shaped bend to trap an amount of water necessary to prevent sewer gases from entering through the open drain. Traditional p trap systems are fabricated from either metal or plastic and are comprised of a U-Shaped tubing segment that is coupled to the respective ends of a first conduit leading from the open sink and a second conduit leading to the sewer system or septic tank.

P trap systems are usually assembled by first roughing in the drain pipe from the sink and the drain conduit connecting the sink to the septic or sewer system. Then the P trap is installed between these two pipes by coupling the free ends of the U-shaped tubing to the free ends of the pipes. Typically, the U-shaped tubing is releasably coupled to the ends of the pipes with threaded fittings.

Removing and replacing the P trap may be difficult due to the location of the p trap and the way that current p trap systems are constructed. First, the location of the trap is awkward and typically positioned in a tight space. Second, to remove the U-shaped bend, a user must undo the threaded connections and pull the U-shaped bend from the ends of the pipes. Then the user must ensure that the ends of the replacement U shaped bend are on the same respective plane as the free ends of the pipes and be able to threadingly engage the ends of the U-shaped bend and the free ends of the pipes. This is not easy to accomplish. P traps that are sold as replacement units do not always fit the previous dimensions of the existing plumbing and must be trimmed to size to fit so that the ends of the U-shaped bend fall on the same plane as the respective free ends of the pipes.

To overcome these obstacles, what is required is a p trap system that easily provides a removable p trap system that universally, quickly and efficiently couples a U-shaped bend to any sink plumbing fixture such that a user does not need to alter the size of the ends of the U shaped bend to fit the existing ends of the pipes leading from the sink and to the septic or sewer system.

### SUMMARY OF INVENTION

The present invention relates to replacement p traps for sinks, tubs and any other plumbing system that utilizes P traps in both residential and commercial settings. The present replacement system is comprised of a first threaded conduit segment that will engage with the existing free end of the pipe leading from the sink wherein such conduit includes at least one locking means, a second threaded conduit segment that will engage with the existing free end of the pipe leading to the sewer or septic system wherein such conduit includes at least one locking means, and a U shaped bend wherein each end of the bend includes at least one locking means and wherein each end of the bend is designed to connect with the first and second threaded conduits segments.

The present invention is designed to offer users an effective and efficient way to replace a p trap in any sink plumbing, tub plumbing or other plumbing fixture. The threaded conduit segments are threaded at the top portion of the segments to allow the first threaded conduit segment to engage with the threaded free end of the pipe leading from the sink and the second threaded free end of the pipe to engage with the threaded free end of the pipe leading to the sewer or septic system of any plumbing system. Such threaded conduit segments allow the present invention to be a universal replacement system where the system may replace any existing p traps with ease and efficiency. The benefit of this novel system is that not only does it provide a replacement of the U-shaped tube but it provides an entire replacement system so that users may easily replace the p traps in their plumbing.

Another novel element of the present invention is the releasable locking means which allows the U-shaped bend to be releasably connected to the free ends of the threaded conduit segments. The locking means provide a secure connection between the U-shaped bend and the threaded conduit segments. In a preferred embodiment, the locking means are comprised of a latch or clip type locking mechanism. In such embodiment, each of the threaded conduit segments possess at least two protrusions, projecting members or pins positioned wherein the at least one protrusion, projecting member or pin is positioned on the front surface of such threaded conduit segment and at least one protrusion, projecting member or pin on the opposite surface of each threaded conduit segment. Such locking means further include at least two bracket assemblies that are pivotally mounted to each end of the U-shaped bend. Each bracket assembly has an actuating bar fixed to two supporting members that lie parallel to one another. Each supporting member is pivotally mounted to the top portion of each side of the U-shaped bend such that each set of supporting member faces one another. Each supporting member further possesses at least one notch, cutout, or recess. Such recess corresponds in size and profile to the at least two protrusions, projecting members or pins on each threaded conduit segment. In order to actuate the locking means, the user rotates the actuating bar towards the center of the U-shaped bend. As the actuating bar rotates, the at least two support members also rotate such that the recess becomes aligned with the at least two protrusions, projecting members or pins. As the user continues to push the actuating bar, the at least two protrusions, projecting members or pins come into contact with the recess and as the user continues to rotate the actuating bar, the bracket assembly moves towards a locked or engaged position wherein the U-shaped bend moves into position and is secured to the threaded conduit segments.

The benefit of such locking means is that it allows the user to releasably lock each end of the U bend to the threaded conduit segments with a single hand. By allowing such ease of use, the user can easily lock and unlock each of the U-shaped bends into place simultaneously. Such ability to simultaneously lock and unlock the p trap assembly is a benefit over current p trap systems that require significant effort to couple and release the U-shaped bend from its coupling to the existing pipes. A significant benefit of this system is that the novel locking means allows users quick access to the p-trap to recover items that have fallen down the drain. Such quick access to the U bend and items that have fallen through the drain and trapped by the U-shaped bend is a far superior design to the current p-trap systems.

Another novel aspect of this invention is that the replacement p trap system further includes straining means in order to filter out debris and solid items from entering the body of the U-shaped bend. The straining means may be any conventional straining means including but not limited to a mesh, perforated disk, grate, or any other means to filter or trap debris. In a preferred embodiment, the straining means may be a perforated disk or member positioned in the end of the U-shaped bend located proximally to the threaded conduit segment that connects to the pipe leading to the sink. As water flows from the sink, the straining means allows water to flow through to the body of the U-shaped bend while trapping debris.

### BRIEF DESCRIPTION OF DRAWINGS

FIG. 1 illustrates an exploded perspective of a preferred embodiment of the present invention.

FIG. 2 illustrates an exploded front view of a preferred embodiment of the present invention.

FIG. 3 illustrates a top view of a preferred embodiment of the present invention including a strainer unit nesting in the top portion of one end of the U-shaped bend.

FIG. 4 illustrates a cross sectional view of a preferred embodiment of the present invention including a strainer unit nesting in the top portion of one end of the U-shaped bend.

FIG. 5 illustrates a perspective view of a preferred embodiment of the present invention wherein the locking means have been engaged.

FIG. 6 illustrates a front view of a preferred embodiment of the present invention wherein the locking means have been engaged.

FIG. 7 illustrates a front view of a preferred embodiment of the present invention wherein the locking means have been disengaged.

### DETAILED DESCRIPTION OF THE DRAWINGS

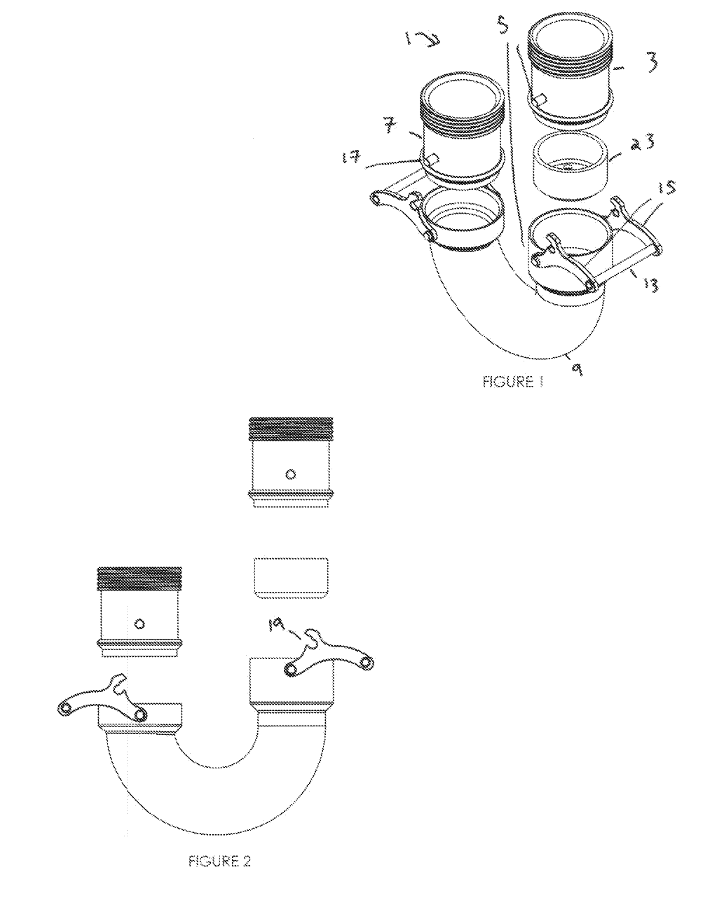

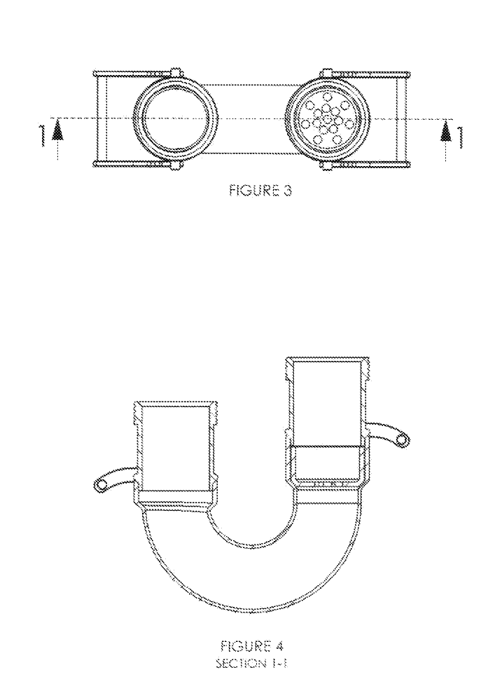

The present invention is shown generally as 1 in FIG. 1. The replacement system of the present invention is comprised of a first threaded conduit segment 3 that will engage with the existing free end of the pipe (not shown) leading from the sink wherein such conduit 3 includes at least one locking means 5, a second threaded conduit segment 7 that will engage with the existing free end of the pipe (not shown) leading to the sewer or septic system wherein such conduit includes at least one locking means 5, and a U shaped bend conduit 9 wherein each end of the bend includes at least one locking means 5 and wherein each end of the bend is designed to connect with the threaded conduits segments.

The components of the present invention may be constructed of any metal material used for plumbing fixtures such as stainless steel, copper, or galvanized steel. Alternatively, the components may be constructed of plastic such as polyvinyl chloride (PVC), chlorinated polyvinyl chloride (CPVC) or PEX pipe. The system may also be constructed of a combination of any such materials for ease of manufacture and minimization of costs.

As shown in FIGS. 1 and 2, the threaded conduit segments are threaded at the top portion of the segments to allow the threaded conduit segments to engage with the threaded free end of the pipe leading from the sink and the threaded free end of the pipe leading to the sewer or septic system of any plumbing system. The threaded conduit segments are sized to work with any existing plumbing fixtures and as such the segments are similar in diameter to the diameters of the existing pipes leading from the sink and leading to the sewer or septic system. The length of such segments are a predetermined length optimized for the segments to work universally with any plumbing drain system.

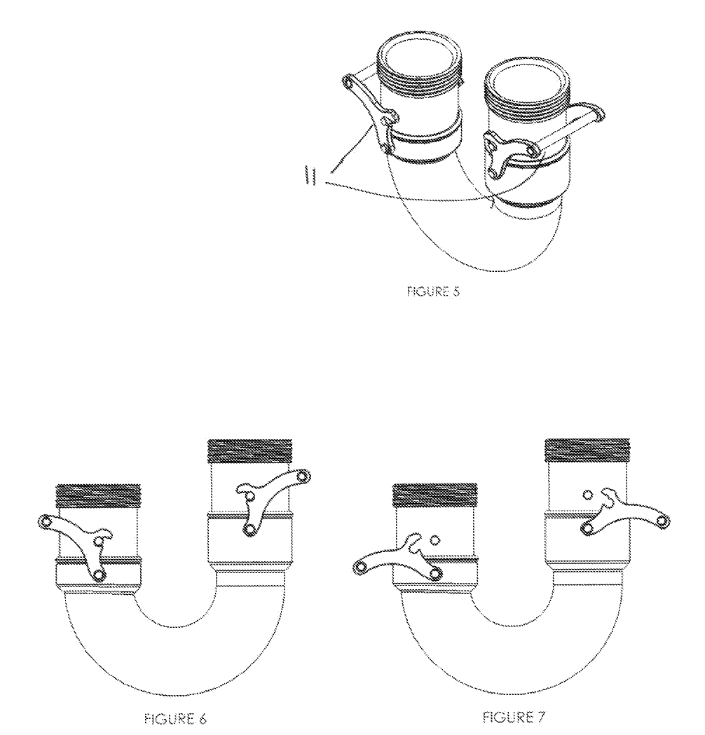

FIGS. 1, 4, 5, and 6 illustrate the releasable locking means 5 which allow the U-shaped bend 9 to be releasably connected to the free ends of the threaded conduit segments. In a preferred embodiment, the locking means are comprised of at least two bracket assemblies 11 that are pivotally mounted to each end of the U-shaped bend. The bracket assembly includes an actuating bar 13 which is fixed to two supporting members 15 that lie parallel to one another. Each supporting member 15 is pivotally mounted to the top portion of each side of the U-shaped bend 9 such that each set of supporting member 15 faces each other.

In order to install the replaceable p trap system, the first and second threaded conduit segments are threaded on to the existing free end of the pipe leading from the sink and the threaded free end of the pipe leading to the sewer or septic system. Once the segments are threaded on to the free ends of the pipes, the ends of the U-shaped bend are aligned with the free ends of the first and second conduit segment. The user then must actuate or “lock” the U-tube bend 9 with the free ends of the threaded conduit segments. Each of the threaded conduit segments possess at least two protrusions, projecting members or pins 17 wherein the at least one protrusion, projecting member or pin 17 is positioned on the front surface of such threaded conduit segment and at least one protrusion, projecting member or pin 17 on the opposite surface of each threaded conduit segment. Such protrusions, projecting members or pins 17 are sized to frictionally fit within the at least one notch, cutout, or recess 19 of the support members 15. In order to actuate the locking means, the user rotates the actuating bar 13 towards the center of the U-shaped bend. As the actuating bar 13 rotates, the at least two support members 15 also rotate such that the recess 19 becomes aligned with the at least two protrusions, projecting members or pins 17. As the user continues to push the actuating bar 13, the at least two protrusions, projecting members or pins 17 come into contact with the recess and as the user continues to rotate the actuating bar, the protrusion, projecting member or pin 17 becomes frictionally engaged with such recess 19 to “lock” the U bend shape into position as shown in FIG. 6. The recessed area of the supporting member may be shaped to further provide a ridge or other means to provide additional support to such locking means.

To release or disengage the locking means, the user may rotate the actuating bar away from the center of the U-shaped bend to disengage the bracket assembly from the at least one protrusion, projecting member or pin 17.

Although a preferred embodiment of the locking means is illustrated in the Figures, any conventional releasable locking means may be used, including but not limited to any fasteners, latches, clips, cam levers, or any lever and/or cam operated locking means.

In a preferred embodiment, the top portions of the U-shaped bend have sections 21 in which the diameter is larger than the diameter of the U bend at the bottom of the U bend. Such larger diameter sections are designed to allow the ends of the threaded conduit segments to fit within or nest within such sections. As shown in FIGS. 1,2, and 4, the wider diameter of such sections allows the ends of the threaded conduit segment to fit concentrically within such sections.

In a preferred embodiment, at least two sealing gaskets are sized and shaped to seal the connection between the sections and the threaded conduit segments to provide a leak proof connection.

The replacement p trap system is further comprised of straining means 23 in order to filter out debris and solid items from entering the body of the U-shaped bend. The straining means 23 may be any conventional straining means including but not limited to a mesh, perforated disk, grate, or any other means to filter or trap debris. In a preferred embodiment, the straining means may be a perforated disk or member positioned in the end of the U-shaped bend located proximally to the threaded conduit segment that connects to the pipe leading to the sink. In one embodiment, the straining means may be constructed to allow the straining means to be disposable and replaceable.

The foregoing detailed description is given for clearness of understanding only, and no unnecessary limitations should be understood therefrom, as modifications will be obvious to those skilled in the art.

1. A replacement P trap system for sinks, tubs and any other plumbing system that utilizes P traps having plumping pipes, such replacement P trap system comprising:
a. a first threaded conduit segment that will engage with a free end of a plumbing pipe wherein such first threaded conduit includes at least one releasable locking means;
b. a second threaded conduit segment that will engage with the free end of a plumbing pipe wherein such conduit includes at least one locking means;
c. a tubular U shaped conduit body having an exterior surface and an interior surface and having a first end and second end wherein the first end of the tubular U shaped conduit body having locking means releasably connects with the first threaded conduit and wherein the second end of the U shaped conduit body having locking means releasably connects with the second threaded conduit segment; and
d. straining means.

2. The replacement P trap system of claim 1 wherein the locking means are comprised of a bracket assembly that is pivotally mounted to the first end of the tubular U-shaped conduit body and second end of the tubular U shaped conduit body.

3. The replacement P trap system of claim 2 wherein the locking means include an actuating bar that releasably connects the first end of the tubular U shaped conduit body connects with the first threaded conduit and the second end of the tubular U shaped conduit body connects with the first threaded conduit.

4. The replacement P trap system of claim 1 wherein the locking means are comprised of a latch assembly that is mounted to the first end of the tubular U-shaped conduit body and second end of the tubular U shaped conduit body.

5. The replacement P trap system of claim 1 wherein the straining means are comprised of a perforated disk.

6. A replacement P trap system for sinks, tubs and any other plumbing system that utilizes P traps having plumping pipes, such replacement P trap system comprising:
a. a first threaded conduit segment;
b. a second threaded conduit segment;
c. a tubular U shaped conduit body having an exterior surface and an interior surface and having a first end and second end wherein the first end of the tubular U shaped conduit body having locking means releasably connects with the first threaded conduit and wherein the second end of the U shaped conduit body having locking means releasably connects with the second threaded conduit segment; and
d. straining means.

7. The replacement P trap system of claim 6 wherein the locking means are comprised of a bracket assembly that is pivotally mounted to the first end of the tubular U-shaped conduit body and second end of the tubular U shaped conduit body.

8. The replacement P trap system of claim 7 wherein the locking means include an actuating bar that releasably connects the first end of the tubular U shaped conduit body connects with the first threaded conduit and the second end of the tubular U shaped conduit body connects with the first threaded conduit.

9. The replacement P trap system of claim 6 wherein the locking means are comprised of a latch assembly that is mounted to the first end of the tubular U-shaped conduit body and second end of the tubular U shaped conduit body.

10. The replacement P trap system of claim 6 wherein the straining means are comprised of a perforated disk.

11. A replacement P trap system for sinks, tubs and any other plumbing system that utilizes P traps having plumping pipes, such replacement P trap system comprising:
a. a first threaded conduit segment;
b. a second threaded conduit segment;
c. a tubular U shaped conduit body having an exterior surface and an interior surface and having a first end and second end wherein the first end of the tubular U shaped conduit body having locking means releasably connects with the first threaded conduit and wherein the second end of the U shaped conduit body having locking means releasably connects with the second threaded conduit segment.

12. The replacement P trap system of claim 11 wherein the locking means are comprised of a bracket assembly that is pivotally mounted to the first end of the tubular U-shaped conduit body and second end of the tubular U shaped conduit body.

13. The replacement P trap system of claim 12 wherein the locking means include an actuating bar that releasably connects the first end of the tubular U shaped conduit body connects with the first threaded conduit and the second end of the tubular U shaped conduit body connects with the first threaded conduit.

14. The replacement P trap system of claim 11 wherein the locking means are comprised of a latch assembly that is mounted to the first end of the tubular U-shaped conduit body and second end of the tubular U shaped conduit body.
